(19) United States
(12) Patent Application Publication
(10) Pub. No.: US 2015/0224606 A1
(43) Pub. Date: Aug. 13, 2015

(54) WELDING SYSTEM FOR CONTINUOUS ROD, AND WELDING HEAD THEREFORE

(71) Applicant: Emmanuel L'Ecuyer, Edmonton (CA)

(72) Inventor: Emmanuel L'Ecuyer, Edmonton (CA)

(21) Appl. No.: 14/179,915

(22) Filed: Feb. 13, 2014

(51) Int. Cl. B23K 37/053; B23K 20/00

(52) U.S. Cl. CPC B23K 37/053; B23K 20/002

(57) ABSTRACT

The welding system can be used for welding rod segments into a continuous rod and includes: a structural frame; a rod path extending along a rod path axis; a first jaw and a second jaw both positioned along the rod path, and both mounted to the structural frame, at least one of the first jaw and the second jaw being movable along the rod path; at least a first mount having a first housing made integral to the structural frame, and a first piston slidingly housed within the first housing in a manner to be slidable within the first housing along a first housing axis, wherein one of the jaws being integral to the first piston; and an actuator operable to selectively move the jaws towards or away from one another and to apply pressure against the ends of the rod segments for welding.

The improvements generally relate to the field of oil production equipment, and more particularly relates to the operation of welding rod sections to form continuous rods for use in oil well pumps.

### BACKGROUND

The use of continuous rods in oil well pumps typically requires welding rod segments to one another in the field. Continuous rods can be used both for progressive cavity pumping and reciprocating cavity pumping. The so-formed continuous rod is used to connect the pump in the well to the pump jack (horse head) located at ground level, or to connect the pump to a rotary motor in the case of progressive cavity pumping.

Although the existing equipment was satisfactory to a certain degree, there remained room for improvement. More specifically, the high pressure exerted between the rod segment ends during welding tended to impart non-negligible elastic deformation in the components, which, in turn, led to slight but undesirable misalignment of the rod segment ends. Simple oversizing the components could reduce the elastic deformation, but also led to a significant increase in cost.

### SUMMARY

In accordance with one aspect, there is provided a welding head for use as part of a welding system for welding rod segments into a continuous rod, the welding system comprising: a structural frame; a rod path extending along a rod path axis at a given position relative to the structural frame; a first jaw and a second jaw both positioned along the rod path for securely receiving corresponding rod segment ends along the rod path, and both mounted to the structural frame, at least one of the first jaw and the second jaw being movable along the rod path; at least a first mount having a first housing made integral to the structural frame, and a first piston slidingly housed within the first housing in a manner to be slidable within the first housing along a first housing axis, wherein one of the first jaw and the second jaw is made integral to the first piston; and an actuator operable to selectively move the jaws towards or away from one another and to apply pressure against the ends of the rod segments for welding.

Many further features and combinations thereof concerning the present improvements will appear to those skilled in the art following a reading of the instant disclosure.

### DESCRIPTION OF THE FIGURES

In the figures,

FIG. 1 is an oblique view of an example of a welding system for continuous rod;

FIG. 2 is an oblique view showing a welding head of the welding system of FIG. 1 in greater detail;

FIGS. 3 to 6 are front views showing subsequent steps of the rod welding process;

FIG. 7 is an exploded view of a longitudinal mount of the welding head of FIG. 2; and

FIG. 8 is a cross-sectional view of a transversal adjustment mount of the welding head of FIG. 2.

### DETAILED DESCRIPTION

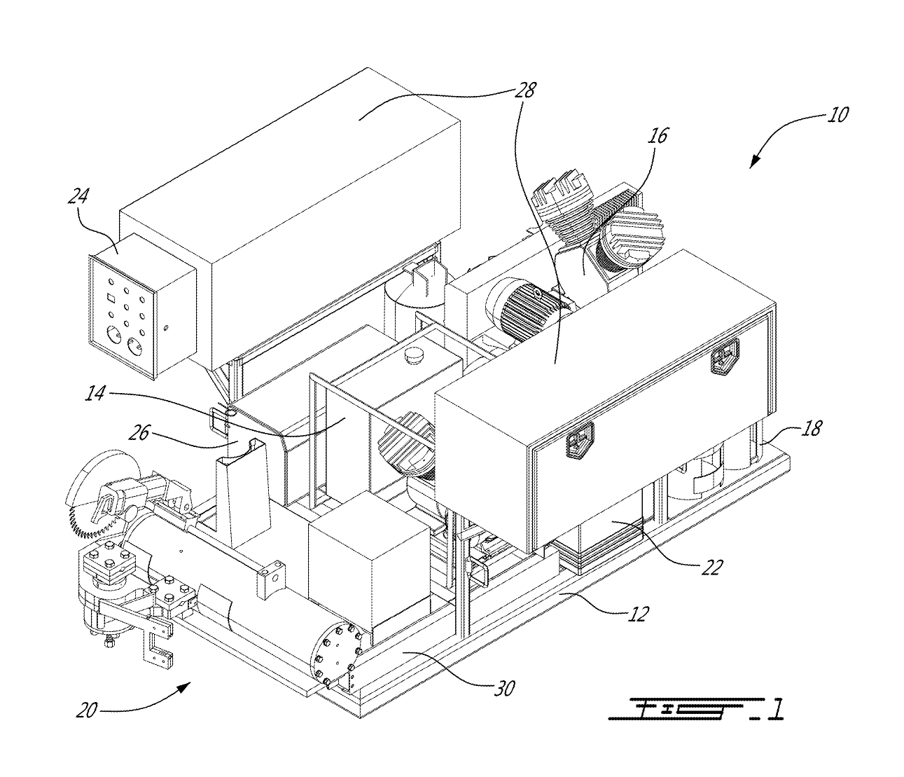

FIG. 1 shows an example embodiment of a welding system 10 incorporating a welding head 20. The welding system 10 can be seen to be generally embodied on a common table 12 allowing it to be integrally placed or removed from the box of a pickup truck (not shown), and generally includes a generator 14 and compressor 16 (both gas powered in this case), heated oxy-acetylene bottle racks 18, a battery 22, an electrical panel 24, a hydraulic powerpack and two toolboxes 28. The welding head 20 is mounted on a slidable drawer arrangement 30 to make it easily slid in and out of the pickup truck.

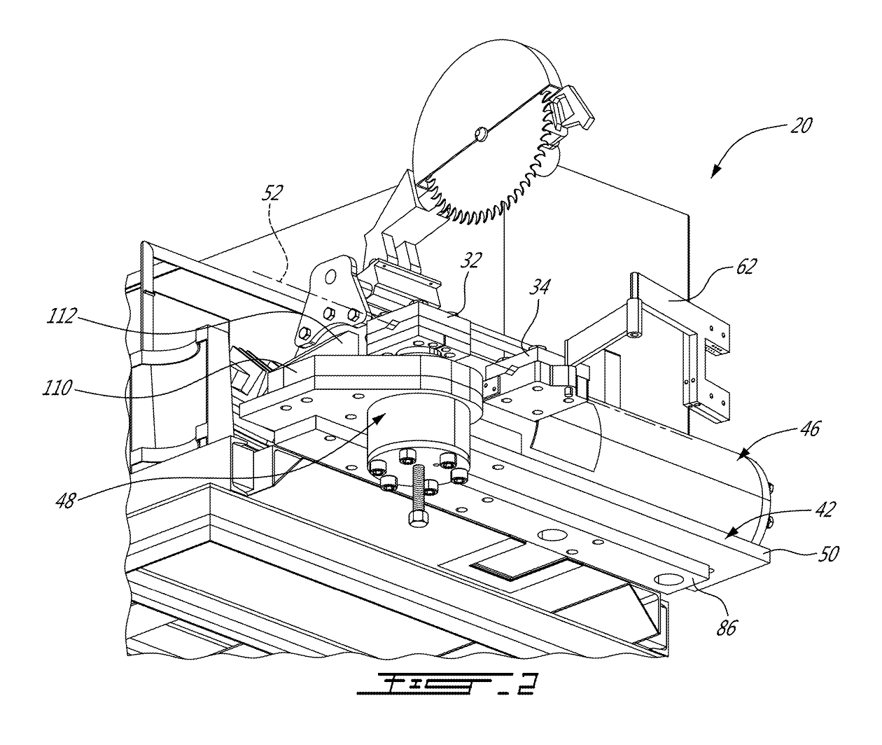

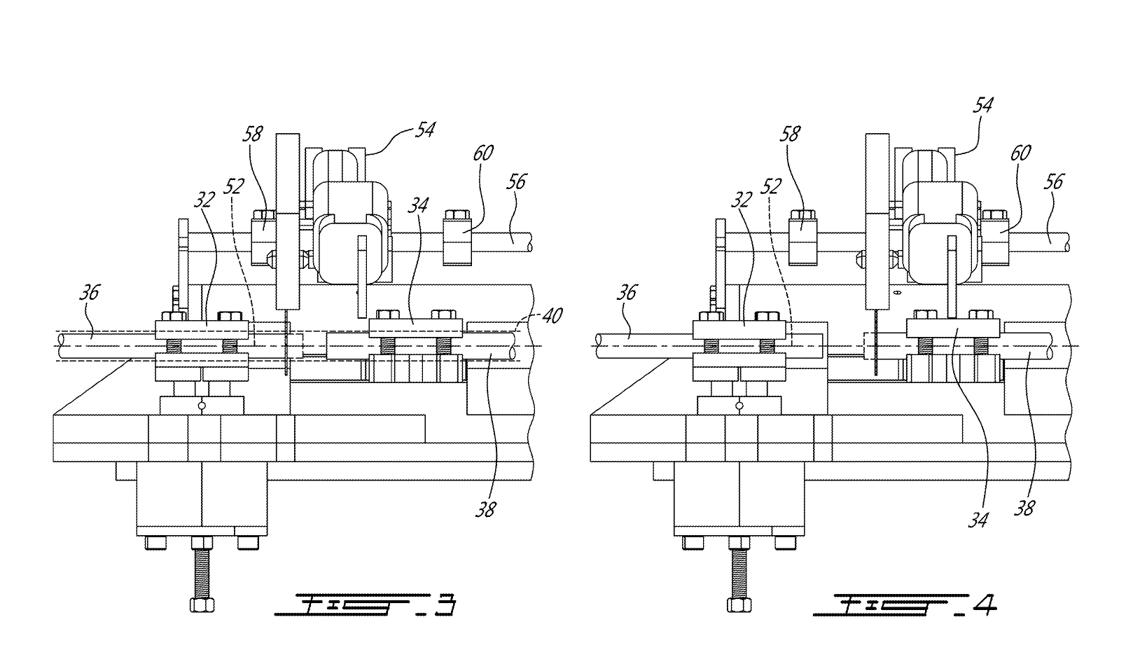

FIG. 2 shows the welding head 20 of this example in greater detail. The welding head 20 generally has two jaws 32, 34 which can be independently open or closed to trap corresponding rod segment ends 36, 38 therein during operation (see FIG. 3). The path along which the rod segments 36, 38 extend when they are trapped in the jaws 32, 34 will be referred herein as a rod path 40 and extends concentrically across both jaws 32, 34 to allow satisfactory welding operation. The jaws 32, 34 are movable towards and away from one another given the way they are mounted to a common structural frame 42, and by way of a longitudinal actuator 44 (see FIG. 4) which is also used to apply a satisfactorily high amount of pressure between the rod segment ends 36, 38 during the welding operation. As shown in FIG. 2, the jaw 34 is mounted to the frame via mount 46 and the jaw 32 is mounted to the frame 42 via mount 48. The frame 42 and mounts 46, 48 are made very sturdy as will be detailed below, and this sturdiness is relevant to maintaining the axial alignment of the rod segment ends 36, 38 independently of the high pressure applied therebetween during the welding operation. In this example, the structural frame 42 includes a thick, rigid metal plate 50 onto which the mounts 46, 48 are sturdily received, to this end. In this specific embodiment, only one of the jaws 34 is movable in the longitudinal orientation of the rod path axis 52 though it will be understood that both jaws can be made longitudinally movable in alternate embodiments; moreover, the other jaw 32 is made transversally adjustable to allow accommodating rod segments 36, 38 having different diameters while maintaining satisfactory axial alignment during operation.

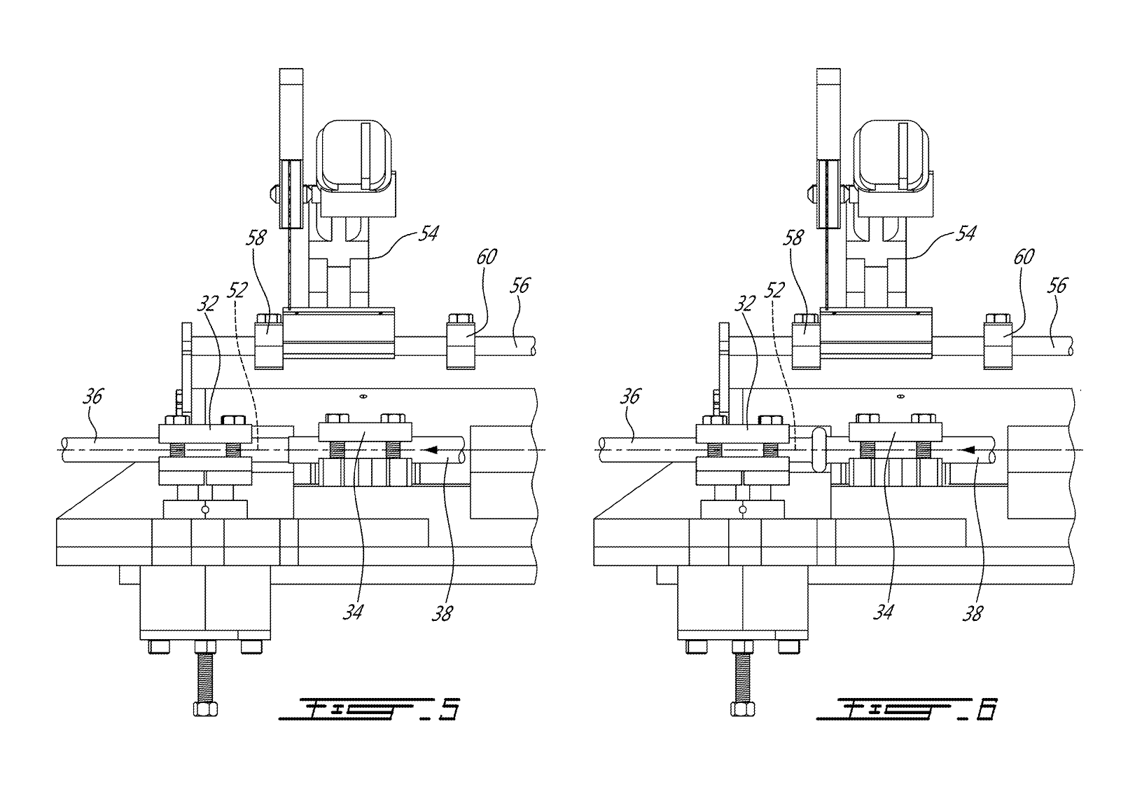

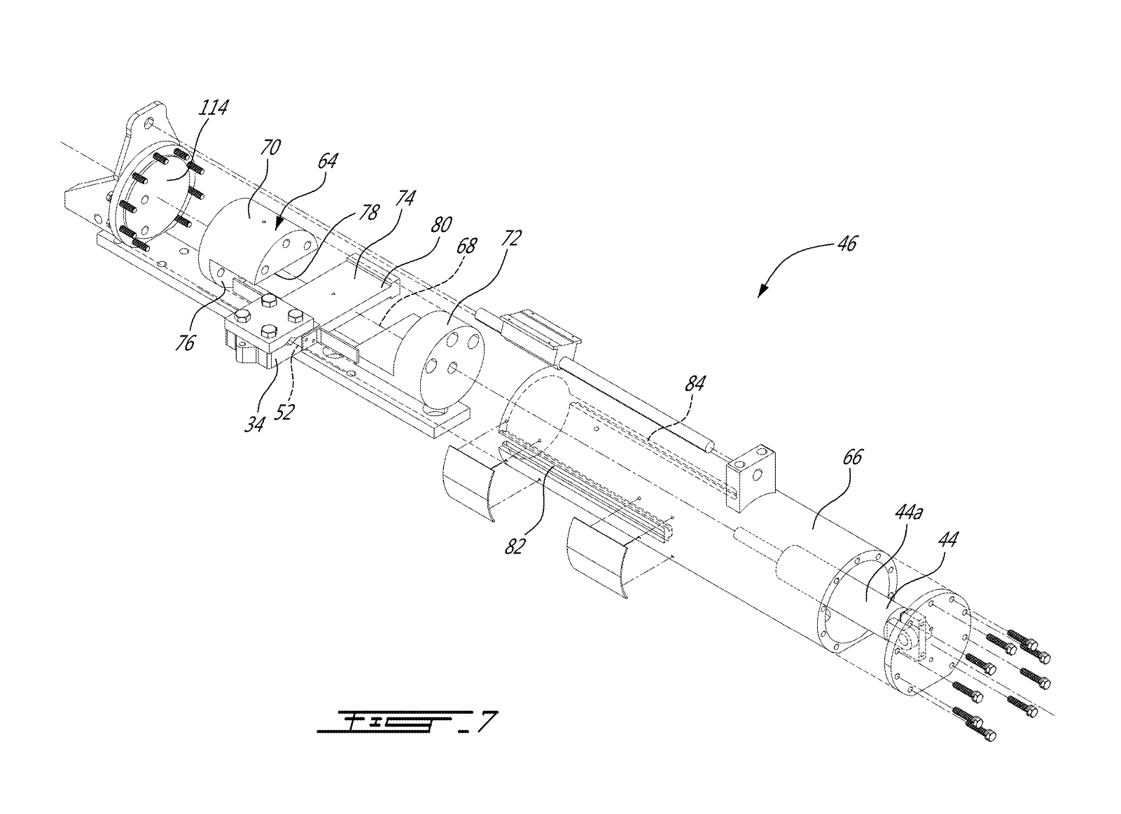

FIGS. 3 to 6 sequentially illustrate a typical welding operation using the illustrated welding head embodiment. As shown in FIG. 3, the jaws 32, 34 are first moved into a longitudinally spaced-apart position and two rod segment ends 36, 38 are mounted into corresponding ones of the jaws 32, 34, into the rod path 40. The height of one of the jaws 32 can be adjusted to obtain a satisfactory alignment of the rod segment ends 36, 38 along a common rod path axis 52. A saw 54 mounted on a longitudinal slider 56 is moved into abutment against a first stopper 58 to cut a first rod segment 36 neatly and perpendicularly, at a given distance from the corresponding jaw 32. Turning now to FIG. 4, the saw 54 is moved into abutment against the other stopper 60 to cut the second rod segment 38 neatly and perpendicularly, at a given distance from the corresponding jaw 34. The jaws 32, 34 are then moved toward one another until the rod segments 36, 38 come into concentric, coaxial abutment (FIG. 5), and then heat and longitudinal pressure are applied to form the weld therebetween, as shown in FIG. 6. The heat is applied by way of a double hinged torch 62 in this embodiment, which can be seen in FIG. 2.

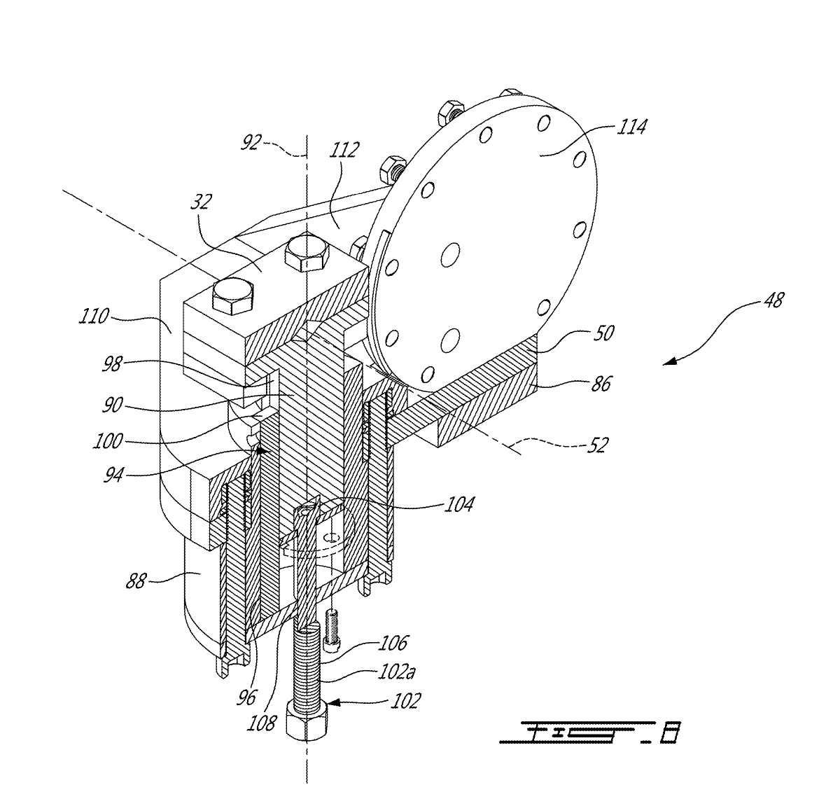

FIG. 7 shows the detailed construction of the longitudinal mount 46 by which the longitudinally movable jaw 34 is moved longitudinally relative to the other jaw 32 and to the structural frame 50 to bring the rod segment ends 38, 36 together and apply the welding pressure therebetween during the welding operation. To achieve a satisfactory ruggedness in this case, the longitudinal mount 46 has a housing 66 which is made of a thick metal cylinder having 9 inches in diameter and 1 inch thickness in this specific case. A piston 64 is slidably housed within this cylinder, and the longitudinally movable jaw 34 is made integral to this piston as will be detailed below. A hydraulic cylinder 44a is used as the longitudinal actuator in this specific case, and this hydraulic cylinder 44a is housed within the housing 66 and is made operable to extend longitudinally along the longitudinal axis 68 to slidingly move the piston 64 in the housing 66. In this embodiment, the jaw 34 is made integral to the piston 64 by the modular construction of the piston 64 which is formed of two halves 70, 72 which are firmly securable to one another with a neck 74 of the jaw 34 trapped therebetween. More specifically, both piston halves 70, 72 have a base 76 and an extending portion 78, the extending portion 78 extending longitudinally from the base 76 and being designed to be securely fastened to the base of the other one of the piston halves 70, 72. Once assembled, the neck 74 of the jaw 34 snugly extends between the extending portions and the bases of the two piston halves 70, 72 and is trapped therein. In this embodiment, the neck 74 has a narrow center 80 provided transversally between two opposite thicker portions. The narrow center 80 is dimensioned to correspond to the size of the spacing between the extending portions of the piston halves 70, 72 when assembled, and the thicker portions are designed to abut against corresponding sides of the piston halves 70, 72 once assembled, thus locking the transversal position of the jaw 34 when the two piston halves 70, 72 are assembled. A front neck aperture 82 is provided in the front of the housing and allows the neck 74 to protrude therefrom to the jaw 34. In this specific embodiment, a rear neck aperture 84 is also provided in the rear of the housing 66, opposite the front neck aperture 82, and allows a distal end of the neck 74 to protrude in the opposite direction. A limit switch arrangement can be provided at the rear to detect the position of the jaw 34 by abutment against the distal end, for instance, which can be used to automate the welding operation, for instance.

Referring back to FIG. 2, it will be noted that the sturdy longitudinal housing 66 is firmly secured onto a thick, rigid plate 50 which forms part of the structural frame 42. The rigid plate 50 extends along the entire length of the longitudinal housing 66, in a tangential manner, which provides a great amount of structure in its plane. The other jaw 32, in this example, is located at a fixed location in the rigid plate plane and the presence of the rigid plate 50 can help maintaining this fixed location satisfactorily well upon exertion of welding operational pressure. The fact that the piston 64, neck 74, and longitudinal housing 66 are precisely machined within tight tolerances, combined with the presence of the rigid plate 50, also contributes to impede disalignment of the rod sections 36, 38 during welding. In this specific embodiment, a lower reinforcement plate 86 is further provided under the longitudinal housing 66 and provides additional structural resistance in the plane of the rigid plate 50.

Turning now to FIG. 8, it will be noted that the jaw 32 which is not on the longitudinal mount 46 is mounted to the structural frame 42 via a transversal adjustment mount 48. The transversal adjustment mount 48 has a corresponding housing 88 which is oriented transversally, and also has a corresponding piston 90 which is movable within the housing 88, along a transversal axis 92, in order to move the jaw 32 transversally across the rod path axis 52 in a manner to allow maintaining axial alignment between rod segments 36, 38 of different diameters. More specifically, the housing 88 is cylindrical and the piston 90 and housing 88 are engaged to one another via a keyway arrangement 94 which prevents the piston 90 from rotating around the transversal axis 92 in the housing 88. More specifically, keyways 96, 98 are provided in both the piston 90 and the housing 88, and a precisely machined key 100 is provided in engagement with both keyways 96, 98 to prevent the piston 90 rotation while allowing smooth movement along the transversal axis 92. The transversal movement of the transversal jaw 32 is provided in this embodiment by way of a secondary actuator 102 which can be referred to as a transversal adjustment actuator. In this specific case, the secondary actuator 102 has a threaded rod 102a with a head 104 which is axially trapped within the piston 90 but which is free to rotate therein, and the stem 106 thereof is threadingly engaged with a corresponding threaded bore 108 provided in an end of the housing 88, in such a manner that rotation of the threaded rod 102a drives the movement of the piston 90 in the housing 88 along the transversal axis 92. During operation, the strong pressure exerted on the jaw 32 in the direction of the rod path axis 52 can tend to pivot the transversal axis 92, which could lead to disalignment of the rod sections 36, 38. The rigidity of the rigid plate 50 and the fact that the housing 88 is snugly housed therein acts against this. Nonetheless, in this embodiment, this potential effect is further countered in the following manner: an upper reinforcement plate 110 is secured immediately above the rigid plate 50 and the transversal mount 48 is firmly secured to the upper reinforcement plate 110, across the rigid plate 50. Moreover, a force transfer plate 112 extends normally above the upper reinforcement plate 110 and is secured both to the upper reinforcement plate 110 and an end 114 of the longitudinal housing 66, above the lower reinforcement plate 86. The resulting arrangement was found satisfactorily sturdy to withstand the operating pressure exerted between the rod segments 36, 38 during welding and thus maintain axial alignment between the rod section ends during operation.

As can be seen from the above, the examples described above and illustrated are intended to be exemplary only. Various alternate embodiments can be readily designed by persons skilled in the art using the teachings of the instant specification. For instance, the welding head can be scaled while using some or all of the operating principles described herein; both jaws can be made longitudinally movable; the transversal adjustment feature is optional, or could be provided on a jaw which is longitudinally movable. Also, although the illustrated embodiment is particularly adapted to working on the field, it will be understood that the concepts described herein can be readily adapted to a fixed application destined for use in a suitable facility. Accordingly, the scope is indicated by the appended claims.

What is claimed is:

1. A welding head for use as part of a welding system for welding rod segments into a continuous rod, the welding head comprising:
a structural frame;
a rod path extending along a rod path axis at a given position relative to the structural frame;
a first jaw and a second jaw both positioned along the rod path for securely receiving corresponding rod segment ends along the rod path, and both mounted to the structural frame, at least one of the first jaw and the second jaw being movable along the rod path;
at least a first mount having a first housing made integral to the structural frame, and a first piston slidingly housed within the first housing in a manner to be slidable within the first housing along a first housing axis, wherein one of the first jaw and the second jaw is made integral to the first piston; and
an actuator operable to selectively move the jaws towards or away from one another and to apply pressure against the ends of the rod segments for welding.

2. The welding head of claim 1, wherein the first housing axis is oriented parallel to the rod path, the second jaw is made integral to the first piston and protrudes transversally from the first piston across a first jaw neck aperture provided across a corresponding portion of the first housing.

3. The welding head of claim 2 wherein a jaw neck made integral to the second jaw extends snugly into and is secured to the first piston.

4. The welding head of claim 3 wherein the jaw neck further protrudes across a second jaw neck aperture provided across a rear portion of the first housing, transversally opposite the first jaw neck aperture.

5. The welding head of claim 3 wherein the first piston is comprised of two halves assembled to one another with the jaw neck trapped therebetween.

6. The welding head of claim 5 wherein a first one of the two halves has a portion extending above the jaw neck and assembled to a second one of the two halves, and the second half has a portion extending below the jaw neck and assembled to the first half.

7. The welding head of claim 2 further comprising a second mount having a second housing made integral to the structural frame, and a second piston slidingly housed within the second housing in a manner to be slidable within the second housing along a second housing axis oriented normal to the rod path axis, wherein the first jaw is made integral to the second piston and protrudes axially from the second piston, further comprising a secondary actuator operable to slidably adjust the position of the second piston relative to the second housing.

8. The welding head of claim 7 wherein the structural frame has a rigid plate extending parallel to the rod path and being made integral to both the first housing and the second housing.

9. The welding head of claim 8 wherein both housings are cylindrical, the rigid plate is secured tangentially to the first housing, and the second housing extends transversally across the rigid plate.

10. The welding head of claim 9 further comprising a lower reinforcement plate extending along the rigid plate, opposite the first housing, and an upper reinforcement plate surrounding the second housing.

11. The welding head of claim 10 further comprising a force transfer plate extending normal to the upper reinforcement plate and structurally connecting the upper reinforcement plate and an end of the first housing.

12. The welding head of claim 1 wherein the first housing axis is oriented normal to the rod path axis, the first jaw is made integral to the first piston and protrudes axially from the first piston, further comprising a secondary actuator operable to slidably adjust the position of the first piston relative to the first housing.

13. The welding head of claim 12 wherein the first piston and the first housing are engaged to one another by a keyway arrangement preventing rotation of the first piston around the first housing axis.

14. The welding head of claim 13 wherein the secondary actuator has a threaded stem engaged with a threaded bore provided in an end of the first housing, opposite the first jaw, the threaded stem having a head trapped within the first piston in a freely rotatable manner, and an actuation end opposite the head, the actuation end being rotatable to slidingly adjust the position of the first piston.
